(19) United States
(12) Patent Application Publication
(10) Pub. No.: US 2004/0118251 A1
(43) Pub. Date: Jun. 24, 2004

(54) Wire stripper

(76) Inventors: Craig Wilson, Brown Deer, WI (US); Thomas M. Luebke, Menomonee Falls, WI (US)

Correspondence Address: QUARLES & BRADY LLP, 411 E. WISCONSIN AVENUE, SUITE 2040, MILWAUKEE, WI, 53202-4497, US

(21) Appl. No.: 10/636,107

(22) Filed: Aug. 7, 2003

Related U.S. Application Data
(60) Provisional application No. 60/402,877, filed on Aug. 9, 2002.

(51) Int. Cl. H02G 1/12

(52) U.S. Cl. 81/9.44; 7/107

(57) ABSTRACT

A hand held wire stripper has ergonomic handles and special cutting blades on two pivotally connected lever members defining the handles and offset jaws having working edges adjacent each other when the wire stripper is in a closed position. The jaws have aligned cutting blade sections at the working edges that taper from the edges in at least two oblique angles with respect to the edges. In addition or alternatively, the cutting blade section defines a plurality of serrations aligned with the serrations of the other lever member. The elongated handles each have a rear grip and a forward grip separated by an outward extension. The forward grips extend forward from the outward extensions toward the hinge point so as to receive a thumb and forefinger of a user and allow gripping of the handles adjacent the hinge point.

### CROSS-REFERENCE TO RELATED APPLICATION

This application claims benefit to U.S. Provisional Patent Application No. 60/402,877 filed Aug. 9, 2002.

### STATEMENT OF FEDERALLY SPONSORED RESEARCH OR DEVELOPMENT

Not applicable.

### BACKGROUND OF THE INVENTION

The present invention relates to hand tools and particular to wire strippers for cutting and removing the insulation from electrical conductors.

Wire strippers are well known. They typically include a pair of lever members having handles and opposing jaws. The lever members are joined together by a pivot pin so that the jaws close by squeezing the handles together. The jaws define a series of notches incrementally sized to standard wire gauges so that the insulation can be stripped from the conductor without cutting the conductor. The jaws may also have a bladed section for cutting the length of the conductor and/or the insulation.

Typically, the working edges of the jaws define an oblique surface, usually tapering straight back from the edge at an acute angle, such as 45 degrees. A common problem with such conventional wire strippers is that the cutting edge can dull prematurely due to nicks on the edges, particularly at the blade section, caused by cutting harder materials such as steel wire. A dull edge can prevent the strippers from stripping insulation cleanly and may cause the wire to be crushed or frayed rather than cut. While this can be corrected by sharpening the working edges, people are not likely to do this because of the effort and tools required to do an adequate job.

Accordingly, a wire stripper is needed in the art that is less susceptible to dulling.

### SUMMARY OF THE INVENTION

The invention provides a hand held wire stripper with ergonomic handles and special cutting blades on two pivotally connected lever members defining the handles and offset jaws having working edges adjacent each other when the wire stripper is in a closed position.

In one aspect of the invention, the jaws have aligned blade sections at the working edges that taper from the working edge in at least two oblique angles with respect to the working edge.

The cutting blade sections can define a first acute angled surface adjacent the working edge and a second acute angled surface of an angle greater than the first surface and spaced from the working edge thereby. The first surface is at an approximately 15 degree angle extending approximately 0.03 inches and the second surface is at approximately 45 degrees.

Preferably, the lever members are stainless steel, a spring biases apart the handles and each jaw includes an inwardly extending toothed section at its tip. The working edges have aligned sets of incrementally sized recesses opening inwardly to form incrementally sized openings for stripping insulation from an insulated conductor.

In another aspect of the invention, the cutting blade sections define a plurality of serrations aligned with the serrations of the other lever member. Preferably, the cutting blade sections each taper to the working edge in at least two oblique angles with respect to the working edge.

In yet another aspect of the invention, the elongated handles each have a rear grip and a forward grip separated by an outward extension. The forward grips extend forward from the outward extensions toward the hinge point so as to receive a thumb and forefinger of a user and allow gripping of the handles adjacent the hinge point.

The forward grips are concave opening in a direction away from a centerline extending through the hinge point and along the working edges when in the closed position. Preferably, the forward grips are defined by radii within a range of approximately 1 to 2 inches. The rear grips preferably define at least one raised projection on an outer surface adjacent the outward extensions.

The handles can be symmetrical about the centerline with the rear grips being concave in the direction of the centerline and the forward grips being concave in the direction away from the centerline. Alternatively, one handle can be generally concave opening toward and intersecting the centerline. The other handle is disposed on the side of the centerline opposite the first handle and has a first segment adjacent the outward extension that is concave away from the centerline, a second segment adjacent the first segment that is concave toward the centerline and a third segment adjacent the second segment that is concave away from the centerline and defines a finger retaining lip.

The invention thus provides a wire stripper with working edges that are less likely to dull. The small flatter surfaces of the multi-angled cutting blades improve the strength of the material contacting surface of the working edges and thus reduces the likelihood of the edges being nicked when cutting hard materials. The remainder of the working edges retains the standard 45 degree angle surface to facilitate cutting, particularly of larger diameter materials, so that it is cut cleanly, rather than crushed. The lever members can be made of stainless steel to provide an even harder and corrosion resistant edge. Additionally or alternatively, the working edge can be serrated, so that it is in effect self-sharpening.

The present invention also provides a choice of symmetrical or improved ergonomic handles making it more comfortable to use, particularly when applying increased clamping force.

These and still other advantages of the invention will be apparent from the detailed description and drawings. What follows is a preferred embodiment of the present invention. To assess the full scope of the invention the claims should be looked to as the preferred embodiment is not intended as the only embodiment within the scope of the invention.

### BRIEF DESCRIPTION OF THE DRAWINGS

FIG. 1 is a perspective view of a wire stripper according to the present invention having ergonomically curved handles;

FIG. 2 is a side view thereof;

FIG. 3 is a cross-sectional perspective view of thereof taken along line 3-3 of FIG. 1;

FIG. 4 is an alternate embodiment of the wire stripper having symmetric handles;

FIG. 5 is a side view thereof;

FIG. 6 is top view thereof; and

FIG. 7 is an enlarged view of the jaws of another alternate embodiment of the wire stripper having serrated cutting blades.

### DETAILED DESCRIPTION OF THE PREFERRED EMBODIMENT

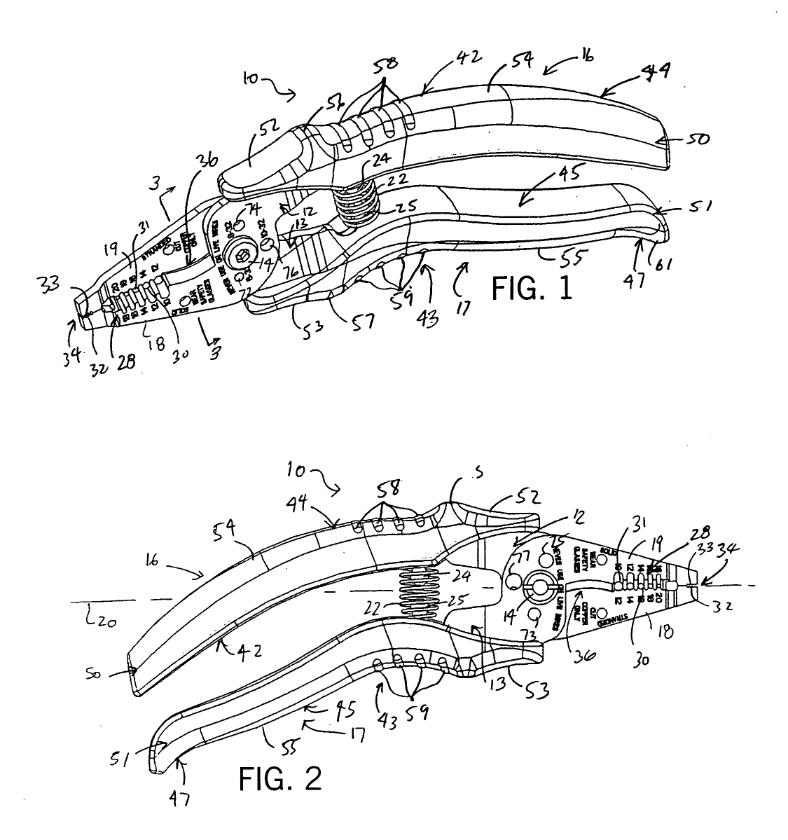

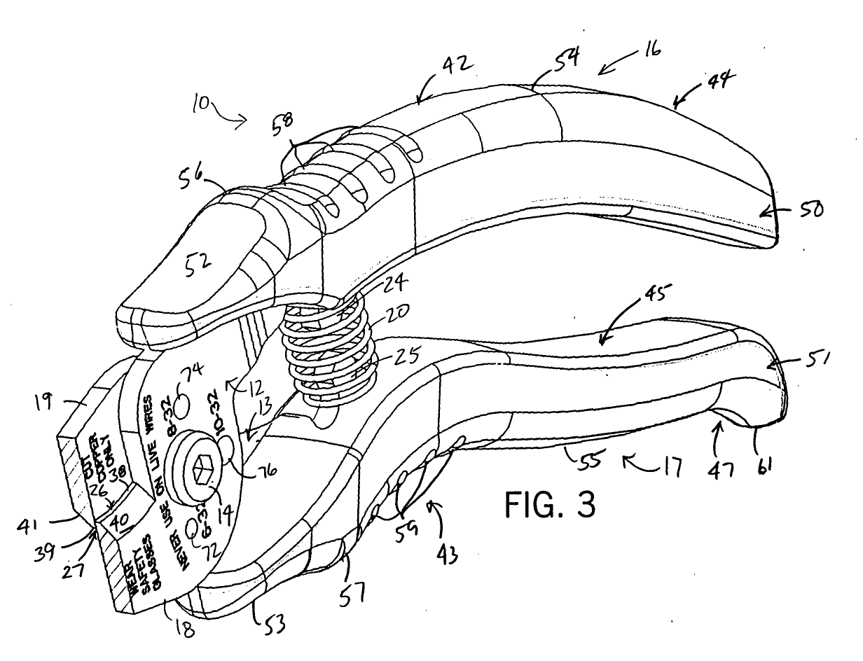

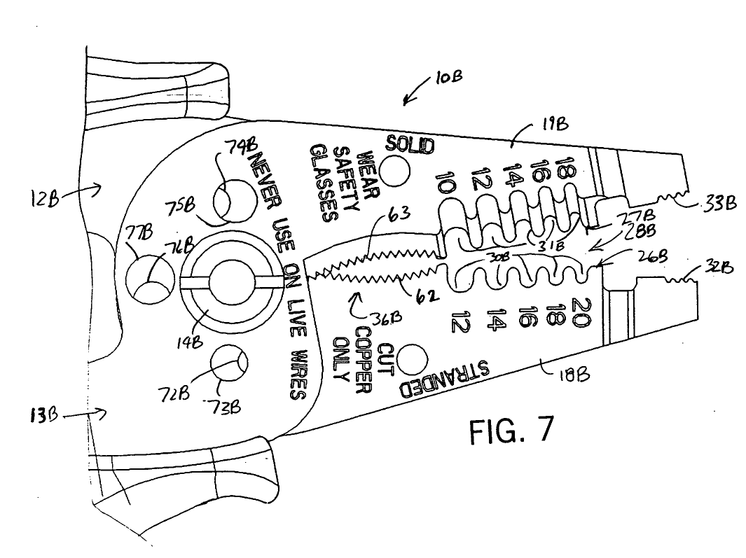

Referring to FIGS. 1-3, a hand-held wire stripper 10 includes two lever members 12 and 13 pivotally connected at a fulcrum or hinge point by a suitable fastener 14. The lever members 12 and 13 have elongated handles 16 and 17 and jaws 18 and 19, respectfully, offset from the handles 16 and 17 about a centerline 20 (see FIG. 2) extending longitudinally through the hinge point. A compression spring 22, secured at its ends to tabs 24 and 25 extending inwardly from the handles 16 and 17, respectively, biases the handles apart so as to bias the jaws 18 and 19 to an open position, such as shown in FIG. 7. Pressing the handles 16 and 17 together compresses the spring 22 and pivots the jaws 18 and 19 about the hinge point until their working edges 26 and 27, respectively, are brought adjacent one another with some overlap, as shown in FIG. 3.

The jaws 18 and 19 include conventional wire stripping and cutting features at the working edges 26 and 27. In particular, the working edges have a notched stripper section 28 defined by a plurality of semi-circular recesses 30 and 31 paired to form a plurality of circular openings when the jaws 18 and 19 are closed. The openings are sized to accommodate standard wire gauges so that the edges surrounding the openings cut through insulation around the wire or cable but do not cut into the conductor. With the five sets of stripper recesses provided, the insulation can be stripped from 12, 14, 16, 18 and 20 gauge wire (1.0, 1.3, 1.6, 2.0 and 2.6 mm). At the tips of the jaws 18 and 19 are a plurality of teeth 32 and 33, respectively, defining a pliers section 34 for gripping and crimping the wire or other objects. Near the base of jaw 18 are three different sized openings 72, 74 and 76 that can be aligned with respective openings 73, 75 and 77 in jaw 19 when the wire stripper is opened for cutting bolts sized 6-32, 8-32 and 10-24, respectively.

The working edges 26 and 27 also define a curved, multi-angled blade section 36 near the hinge point. In particular, referring to FIG. 3, the working edges 26 and 27 have two acute angled oblique surfaces 38 and 40 and 39 and 41, respectively. Surfaces 38 and 39 taper back from their respective working edges 26 and 27 at a relatively flat angle, preferably 15 degrees from horizontal. Surfaces 38 and 39 extend at this flat angle very small distances, on the order of several thousandths of an inch, preferably 0.03 inches. Surfaces 40 and 41 extend away from these flat angled surfaces at sharper angles, such as 45 degrees. This multi-angled blade configuration widens the tips (while maintaining sharp edges) of the blades providing increased surface area contacting the material being cut, thus in effect strengthening the blades and making them less susceptible to being nicked, gouged or otherwise flattened at the working edges. The sharper angled surfaces allows the blades to cut cleanly through the material (particularly larger diameter wire) without crushing the material as may be expected if the cutting surfaces were each at one flat angle.

The lever members 12 and 13 are shaped differently and curved to provide an ergonomically improved grip. In particular, lever member 12 generally defines a simple curve intersecting the centerline 20 and opening concave toward the centerline 20. In one preferred form, the handle portion of this lever member 12 has a proximal segment 42 defined by approximately a 4 inch radius and a distal 44 segment defined by approximately a 5 inch radius. The lever member 13 defines a complex path having three main segments 43, 45 and 47. A first segment 43 toward the hinge point opens concave away from the centerline 20, a second segment 45, which is adjacent to the first segment 43, opens concave toward the centerline 20 (so as to define an inflection point therebetween), and a third segment 47, which is adjacent to the second segment 45 and at the distal end of the handle, opens concave away from the centerline 20 (again defining an inflection point therebetween). In a preferred form, the first segment 43 is defined by approximately a 1.4 inch radius, the second segment 45 is defined by a relatively large radius approximately 8 inches, and the third segment is defined by approximately a 1 inch radius.

For comfort, the lever members 12 and 13 preferably have wide, smooth outer grips 50 and 51. Any suitable rubber or plastic material can be applied in any suitable matter, such as insert molding. The grips generally follow the overall configurations of the lever members 12 and 13 described above. In one preferred form, the rubber grips 50 and 51 extend from the distal ends of the lever members 12 and 13 and terminate approximately at a vertical line perpendicular to the centerline 20 and passing through the hinge point. The grips 50 and 51 define respective forward grips 52 and 53 and rear grips 54 and 55 separated by outward extensions or apexes 56 and 57 formed between the forward and rear grips between the hinge point and the spring 22. The forward grips 52 and 53 open concave outward away from the centerline 20 and thus provide comfortable, finger-wide surfaces for one's thumb (forward grip 52) and fore finger (forward grip 53). Because the forward grips are located at (or near) the hinge point, gripping the wire stripper in this way gives the user increased control when making precise cuts and lowers the effective torque or moment on the user's wrist when pulling the insulation off of wire. The wire stripper could alternatively be held with one's thumb and fingers on the rear grips 54 and 55 only. The grips are contoured behind the outward extensions 56 and 57 and a series of outwardly raised projections or ribs 58 and 59 are formed in the grips for improved grip of the user's thumb and fore finger. The distal end of the rear grip 55 (at the third segment 47 of lever member 13) defines a finger retaining lip 61 to help the user's small finger from slipping off of the handle.

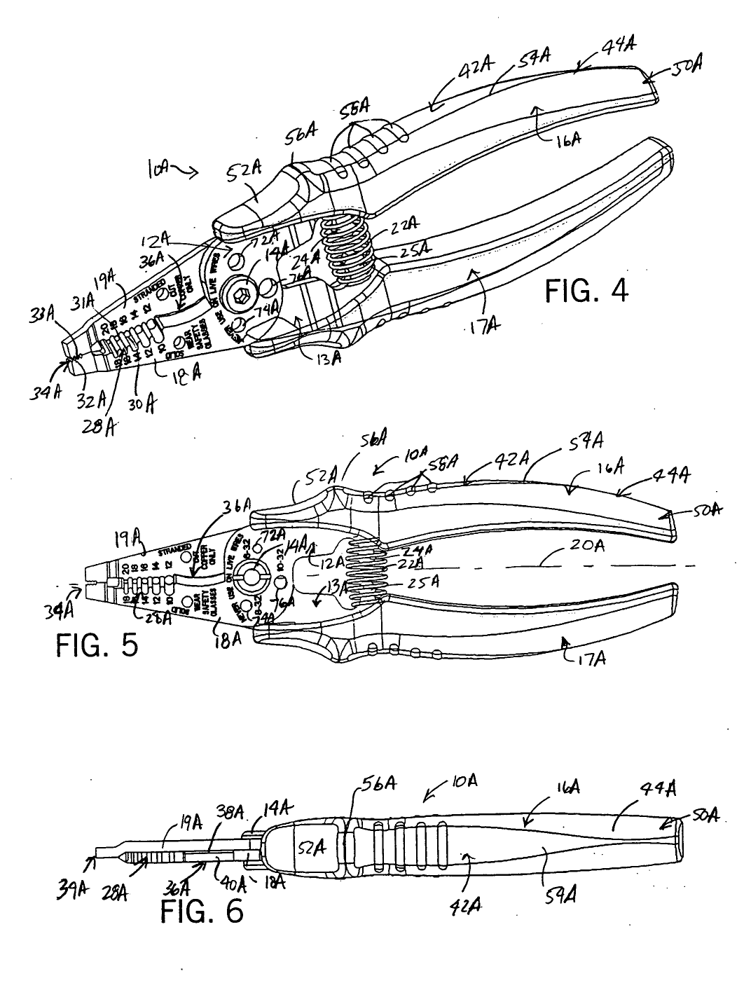

FIGS. 4-6 show an alternate embodiment of the invention identical to the first embodiment except with handles that are symmetrical about the centerline of the strippers. In this embodiment, elements similar to those of the above described embodiment are referred to with like reference numbers albeit with the suffix “A”. Specifically, a wire stripper 10A includes lever members 12A and 13A pivotally connected about a hinge point, as in the above embodiment. The lever members 12A and 13A have elongated handles 16A and 17A and offset jaws 18A and 19A. Tabs 24A and 25A extend inwardly from the handles and mount a compression spring 22A to bias the lever members apart. Like the first embodiment, the jaws 18A and 19A include wire stripping and cutting features identical to that described above with respect to the first embodiment, including a stripper section 28A, a pliers section 34A, a multi-angled blade section 36A and bolt cutting openings 72A-77A.

Unlike the first described embodiment, the lever members 12A and 13A have the same shape and are symmetrical about the centerline 20A. For simplicity, only lever member 12A and its corresponding outer grip 50A will be described in detail. In particular, lever member 12A generally defines a simple curve opening concave toward, but not intersecting, the centerline 20A. In one preferred form, the handle portion of this lever member 12A has a proximal segment 42A defined by approximately a 3-5 inch radius (preferably 4 inches) and a distal 44A segment defined by approximately a 4-6 inch radius (preferably 5 inches). Like above, the lever member 12A has a wide, smooth outer grip 50A made of any suitable rubber or plastic material generally following the overall configuration of the lever member 12A. In one preferred form, the rubber grip 50A extends from a distal end of the lever member 12A and terminates approximately at a vertical line perpendicular to the centerline 20A and passing through the hinge point. The grip 50A defines a forward grip 52A and a rear grip 54A separated by an outward extension or apex 56A formed between the forward and rear grips between the hinge point and the spring 22A. The forward grip 52A opens concave outward away from the centerline 20A and provides a comfortable, finger-wide surface for one's thumb (the fore finger can rests on the forward grip of the other lever member 13A). The grip is contoured behind the outward extension 56A and a series of outwardly raised projections or ribs 58A are formed therein for improved grip when grasped with one's thumb and fingers on the rear grip only.

FIG. 7 shows another alternate embodiment of the wire stripper with a serrated blade section, which could be either in a single angled form or the multi-angled form described above. Specifically, in this alternate embodiment the elements similar to those of the above described embodiments are referred to with like reference numbers albeit with the suffix “B”. Specifically, wire stripper 10B includes lever members 12B and 13B pivotally connected about a hinge point, as in the above embodiment. The lever members 12B and 13B have elongated handles and offset jaws 18B and 19B. Like the first embodiment, the jaws 18B and 19B have working edges 26B and 27B that define a notched stripper section 28B (with recesses 30B and 31B), a pliers section 34B (with teeth 32B and 33B), bolt cutting openings (72B-77B) and a curved blade section 36B. The blade section includes a plurality of serrations 62 and 63 at the working edges. FIG. 4 shows these serrations as being part of a single acute angle (preferably 45 degrees) oblique cutting surface leading from each working edge. However, as mentioned, the cutting surfaces could be multi-angled, with a thin flat acute angled surface (preferably 15 degrees and 0.03 inches wide) leading from the working edges to a second sharper acute angled surface (preferably 45 degrees), as described above. The serrations tend to be self-sharpening and help to remove burrs that can form at the cut edges of the wires (or other materials) as the serrations are worked through the material.

The invention thus provides a wire stripper with working edges that are less likely to dull. The small flatter surfaces of the multi-angled cutting blades improve the strength of the material contacting surface of the working edges and thus reduces the likelihood of the edges being nicked when cutting hard materials. The lever members can be made of stainless steel to provide an even harder and corrosion resistant edge. Additionally or alternatively, the working edge can be serrated, so that it is in effect self-sharpening.

It should be appreciated that a preferred embodiment of the invention has been described above. However, many modifications and variations to the preferred embodiment will be apparent to those skilled in the art, which will be within the spirit and scope of the invention. Therefore, the invention should not be limited to the described embodiment. To ascertain the full scope of the invention, the following claims should be referenced.

We claim:

1. A hand held wire stripper having a first lever member and a second lever member each with an elongated handle and an offset jaw having a working edge, the first and second lever members being pivotally joined so that the working edges lie adjacent each other when in a closed position, and wherein the working edge of the first lever member includes a first cutting blade section and the working edge of the second lever member includes a second cutting blade section aligned with the first multi-angled cutting blade, wherein the first and second cutting blade sections each taper from their working edge in at least two oblique angles with respect to the working edge.

2. The wire stripper of claim 1, wherein the first and second cutting blade sections define a first acute angle surface adjacent the working edge and a second acute angle surface of an angle greater than the first surface and spaced from the working edge by the first surface.

3. The wire stripper of claim 2, wherein the first surface is at approximately a 15 degree angle and the second surface is at approximately a 45 degree angle.

4. The wire stripper of claim 3, wherein the first surface extends approximately 0.03 inches.

5. The wire stripper of claim 1, wherein the lever members are stainless steel.

6. The wire stripper of claim 1, wherein the working edge of the first lever member includes a first set of incrementally sized recesses opening inwardly and the working edge of the second lever member includes a second set of incrementally sized recesses opening inwardly and aligned with the first set so that when the wire stripper is in the closed position the first and second set of recesses form incrementally sized openings for stripping insulation from an insulated conductor.

7. The wire stripper of claim 1, further including a spring biasing apart the handles of the first and second lever members.

8. The wire stripper of claim 1, wherein a tip of each jaw includes an inwardly extending toothed section.

9. A hand held wire stripper having a first lever member and a second lever member each with an elongated handle and an offset jaw having a working edge, the first and second lever members being pivotally joined so that the working edges lie adjacent each other when in a closed position, and wherein the working edge of the first lever member includes a first cutting blade section and the working edge of the second lever member includes a second cutting blade section aligned with the first cutting blade, wherein the first and second cutting blade sections each define a plurality of serrations aligned with the serrations of the other lever member.

10. The wire stripper of claim 9, wherein the first and second cutting blade sections each taper from their working edge in at least two oblique angles with respect to the working edge.

11. A hand held wire stripper has a first lever member pivotally joined to a second lever member about a hinge point, each lever member has an elongate handle and an offset jaw with a working edge positioned adjacent a working edge of the other lever member when in a closed position, each elongated handle has a rear grip and a forward grip separated by an outward extension, the forward grips extend forward from the outward extensions toward the hinge point so as to receive a thumb and forefinger of a user and allow gripping of the handles adjacent the hinge point.

12. The wire stripper of claim 11, wherein the forward grips are concave opening in a direction away from a centerline extending through the hinge point and along the working edges when in the closed position.

13. The wire stripper of claim 12, wherein the forward grips are defined by radii within a range of approximately 1 to 2 inches.

14. The wire stripper of claim 11, wherein the handles are symmetrical about a centerline extending through the hinge point and along the working edges when in the closed position.

15. The wire stripper of claim 14, wherein the rear grips are concave in the direction of the centerline.

16. The wire stripper of claim 15, wherein the forward grips are concave in the direction away from the centerline.

17. The wire stripper of claim 11, wherein the rear grip of the handle of the first lever member is generally concave opening toward a centerline extending through the hinge point and along the working edges when in the closed position and wherein the rear grip of the handle of the second lever member has a first segment adjacent the outward extension that is concave away from the centerline and a second segment adjacent the first segment that is concave toward the centerline.

18. The wire stripper of claim 17, wherein the handle of the first lever member intersects the centerline and the handle of the second lever is disposed on the side of the centerline opposite the handle of the first lever member.

19. The wire stripper of claim 18, wherein the rear grip of the handle of the second lever member has a third segment adjacent the second segment and at an end opposite the hinge point that is concave away from the centerline and defines a finger retaining lip.

20. The wire stripper of claim 17, wherein the forward grips are concave in the direction away from the centerline.

21. The wire stripper of claim 11, wherein each of the rear grips defines at least one raised projection on an outer portion thereof adjacent the outward extensions.
